(19) United States
(12) Patent Application Publication
(10) Pub. No.: US 2011/0310460 A1
(43) Pub. Date: Dec. 22, 2011

(54) Electronic paper display device and method for manufacturing the same

(75) Inventors: Sang Moon Lee, Seoul (KR); Sang Jin Kim, Suwon-si (KR); Jeong Bok Kwak, Suwon-si (KR); Young Woo Lee, Suwon-si (KR); Hwan Soo Lee, Suwon-si (KR)

(73) Assignee: SAMSUNG ELECTRO-MECHANICS CO., LTD., Suwon (KR)

(21) Appl. No.: 12/926,643

(22) Filed: Dec. 1, 2010

(30) Foreign Application Priority Data
Jun. 21, 2010 (KR) 10-2010-0058607

(51) Int. Cl. G02F 1/167

(52) U.S. Cl. 359/296

(57) ABSTRACT

Disclosed herein is an electronic paper display device. The electronic paper display device according to the present invention may include: a base substrate; first rotating balls that are disposed on the front surface of the base substrate; second rotating balls that are disposed on the rear surface of the base substrate; a barrier rib structure that partitions the first rotating balls and the second rotating balls on the base substrate; and an electrode structure that is included in the barrier rib structure and applies voltage to the rotating balls.

### CROSS REFERENCE TO RELATED APPLICATION

This application claims the benefit under 35 U.S.C. Section [120, 119, 119(e)] of Korean Patent Application Ser. No. 10-2010-0058607, entitled “Electronic Paper Display Device And Method For Manufacturing The Same”, filed on Jun. 21, 2010, which is hereby incorporated by reference in its entirety into this application.

### BACKGROUND OF THE INVENTION

1. Technical Field

The present invention relates to an electronic paper display device and a method for manufacturing the same, and more particular, to an electronic paper display device improving color sharpness and contrast ratio and a method for manufacturing the same.

2. Description of the Related Art

An electronic paper display device, which is one of next-generation display devices, has larger availability and flexibility than other display devices and can be driven at a low power. Therefore, the electronic paper display device can replace a paper printing medium such as books and can be applied to various kinds of screens and electronic wallpapers, etc.

As a representative electronic paper display device, there is an electronic paper display device using a rotating ball formed of hemispheres having different colors. A twist ball type electronic paper display device includes a plurality of rotating balls, a barrier rib structure partitioning the rotating balls, an electrode structure rotating the rotating balls, and a transparent insulating oil providing lubrication to the rotating balls, etc.

Recently, a demand for the electronic paper display device with the improved sharpness and contrast ratio is being increased. To this end, there is a need to increase the number of rotating balls per a unit area. For this purpose, there is a need to reduce an interval between cavities in which the rotating balls are disposed in the barrier rib structure. However, an imprint method, a sandblast method, and a laser processing method, which have been prevalently used as a method of forming the barrier rib structure, have a limitation to reduce the interval between the cavities.

In addition, most of electronic paper display devices have a structure where the rotating balls are disposed on a co-plane. However, a dead zone where color is not represented is generated in a gap between the rotating balls. Considering the structure of the rotating balls having the spherical shape, the gap is inevitably generated between the rotating balls, such that it is difficult to improve color sharpness and contrast ratio.

### SUMMARY OF THE INVENTION

An object of the present invention is to provide an electronic paper display device with the improved color sharpness and contrast ratio.

Another object of the present invention is to provide an electronic paper display device with the increased number of rotating balls per a unit area.

Another object of the present invention is to provide an electronic paper display device capable of reducing a dead zone where color is not represented in a gap between the rotating balls.

Another object of the present invention is to provide a method for manufacturing an electronic paper display device with the improved color sharpness and contrast ratio.

Another object of the present invention is to provide a method for manufacturing an electronic paper display device with the increased number of rotating balls per a unit area.

Another object of the present invention is to provide a method for manufacturing an electronic paper display device capable of reducing a dead zone where color is not represented in a gap between the rotating balls.

According to an exemplary embodiment of the present invention, there is provided an electronic paper display device, including: a base substrate; first rotating balls that are disposed on the front surface of the base substrate; second rotating balls that are disposed on the rear surface of the base substrate; and a barrier rib structure that partitions the first rotating balls and the second rotating balls on the base substrate and is made of a photoreactive barrier rib material.

The first rotating balls and the second rotating balls may be disposed to have a zigzag structure to each other based on the base substrate.

The plane arrangement of the first rotating balls and the second rotating balls may have a structure where one center of the second rotating ball is positioned at a connection point of lines connecting the centers of the first rotating balls facing each other in a diagonal direction among four first rotating balls.

The barrier rib structure may include: a first barrier rib that is disposed on the front surface of the base substrate to partition the first rotating balls; and a second barrier rib that is disposed on the rear surface of the base substrate to partition the second rotating balls, wherein the first barrier rib and the second barrier rib includes different kinds of photoreactive barrier rib materials.

The barrier rib structure may include: a first barrier rib that is disposed on the front surface of the base substrate to partition the first rotating balls; and a second barrier rib that is disposed on the rear surface of the base substrate to partition the second rotating balls, wherein the first barrier rib includes a photoreactive barrier rib material reacting to light having different wavelengths as compared to the second barrier rib.

The barrier rib structure may include: a first barrier rib that is disposed on the front surface of the base substrate to partition the first rotating balls; and a second barrier rib that is disposed on the rear surface of the base substrate to partition the second rotating balls, and wherein at least first barrier rib of the first barrier rib and the second barrier rib is made of a light transmitting material.

The barrier rib structure may include cavities in which the first rotating balls and the second rotating balls are disposed, the cavities having a cylindrical shape.

The barrier rib structure may include cavities in which the first rotating balls and the second rotating balls are disposed, and the upper diameter and the lower diameter of the cavities are the same as each other.

The barrier rib structure may include: first cavities in which the first rotating balls are disposed; and second cavities in which the second rotating balls are disposed, and wherein the first cavities and the second cavities is disposed in zigzag to each other based on the base substrate.

The barrier rib structure may include a barrier rib defining the cavities in which the first rotating balls and the second rotating balls are disposed, and wherein the barrier rib is vertical and having a side surface surrounding the cavities.

The barrier rib structure may include a barrier rib defining the cavities in which the first rotating balls and the second rotating balls are disposed, wherein the thickness of the barrier rib of a portion that partitions the rotating balls adjacent to each other among the first rotating balls may be 30 μm or less.

The first barrier rib may include a photoreactive material reacting to any one of g-line, i-line, KrF excimer laser, ArF excimer laser, F2 laser, and extreme ultraviolet (EUV), and the second barrier rib may include a photoreactive material reacting to the other light of g-line, i-line, KrF excimer laser, ArF excimer laser, F2 laser, and extreme ultraviolet (EUV).

The base substrate may include a light transmitting transparent substrate.

The electronic paper display device may further include an electrode structure applying voltage to the rotating balls, wherein the electrode structure may include: an upper electrode that is disposed on the first rotating balls; and a lower electrode that is disposed on the second rotating balls.

According to another exemplary embodiment of the present invention, there is provided an electronic paper display device, including: a base substrate; rotating balls that are disposed on the base substrate by being divided on two or more different planes; and a barrier rib structure that partitions the rotating balls, wherein the barrier rib structure is formed by performing a photolithography.

The rotating balls disposed on different planes among the rotating balls may be disposed in zigzag to each other based on the base substrate.

The rotating balls disposed on any one plane among the rotating balls may be disposed to be opposite to a region between the rotating balls disposed on the other plane.

The rotating balls may include: first rotating balls that are disposed on any one plane on the base substrate; second rotating balls that are disposed on the other plane on the base substrate; and wherein the barrier rib structure may include: a first barrier rib that partitions the first rotating balls; and a second barrier rib that partitions the second rotating balls.

The rotating balls may include: a first rotating balls that are disposed on any one plane on the base substrate; and a second rotating balls that are disposed on the other plane on the base substrate, and wherein the plane arrangement of the first rotating balls and the rotating balls has a structure where one center of the second rotating ball is positioned at a connection point of lines connecting the centers of the first rotating balls facing each other in a diagonal direction among four first rotating balls.

The barrier rib structure may include: a first barrier rib that partitions the rotating balls disposed on any one plane of the base substrate; and a second barrier rib that partitions the rotating balls disposed on the other plane of the base substrate, the first barrier rib including a photoreactive barrier rib material reacting to light having different wavelengths as compared to that of the second barrier rib.

The rotating ball may include: first rotating balls that are disposed on any one plane on the base substrate; and second rotating balls that are disposed on the other plane on the base substrate, and wherein the electrode structure may include: an upper electrode that covers the first rotating balls on the front surface of the base substrate; and a lower electrode that covers the second rotating balls on the rear surface of the base substrate.

According to another exemplary embodiment of the present invention, there is provided a method for manufacturing an electronic paper display device, including: preparing a base substrate; forming a photoreactive barrier rib material on both surfaces of the base substrate; forming cavities in the photoreactive barrier rib material; positioning rotating balls in the cavities; and forming an electrode structure applying voltage to the rotating balls in the barrier rib structure.

The forming the photoreactive barrier rib material may include: forming a first photoreactive barrier rib material on the front surface of the base substrate; and forming a second photoreactive barrier rib material of a type different from the first photoreactive barrier rib materialial on the rear surface of the base substrate.

The forming the photoreactive barrier rib material may include: forming a first photoreactive barrier rib material on the front surface of the base substrate; and forming a second photoreactive barrier rib material reacting to light having a wavelength different from that of the first photoreactive barrier rib material on the rear surface of the base substrate.

The forming the photoreactive barrier rib material may include: forming a first photoreactive material reacting to any one of g-line, i-line, KrF excimer laser, ArF excimer laser, F2 laser, and extreme ultraviolet (EUV) on the front surface of the base substrate; and forming a second photoreactive material reacting to the other light of g-line, i-line, KrF excimer laser, ArF excimer laser, F2 laser, and extreme ultraviolet (EUV) on the rear surface of the base substrate.

The forming the cavities may include: forming first cavities in the photoreactive barrier rib materialial formed on the front surface of the base substrate; and forming second cavities opposite to a region between the first cavities in the photoreactive barrier rib material formed on the rear surface of the base substrate.

The forming the cavities may include: forming first cavities in the photoreactive barrier rib material formed on the front surface of the base substrate; and forming second cavities having a zigzag structure to the first cavities based on the base substrate in the photoreactive barrier rib material formed on the rear surface of the base substrate.

The forming the cavities may include: forming first cavities in the photoreactive barrier rib material formed on the front surface of the base substrate; and forming second cavities in the photoreactive barrier rib material formed on the rear surface of the base substrate, and wherein the forming the cavities and the forming the second cavities are performed in-situ.

The forming the cavities may include: formingfirst cavities in the photoreactive barrier rib material formed on the front surface of the base substrate; and forming second cavities in the photoreactive barrier rib material formed on the rear surface of the base substrate, wherein the forming the first cavities is made by performing a photolithography process using light having a different wavelength as compared to the forming the second cavities.

The positioning the rotating balls in the cavities may include: positioning first rotating balls disposed on the front surface of the base substrate; and positioning second rotating balls to have a zigzag arrangement to the first rotating balls on the rear surface of the base substrate based on the base substrate.

The method for manufacturing an electronic paper display device may further include hardening the photoreactive barrier rib material.

The forming the cavities may include: positioning a first mask on a photoreactive barrier rib material formed on the front surface of the base substrate; positioning a second mask on a photoreactive barrier rib material formed on the rear surface of the base substrate; performing a first exposure process irradiating light having a first wavelength to the photoreactive barrier rib material through the first mask; performing a second exposure process irradiating light having a wavelength different from the first wavelength to the photoreactive barrier rib material through the second mask; and performing a developing process removing a non-light receiving region of the light of the photoreactive barrier rib material.

The first exposure process and the second exposure process may be performed in-situ.

The forming the electrode structure may further include: forming an upper electrode on the front surface of the base substrate; and forming a lower electrode on the rear surface of the base substrate.

### BRIEF DESCRIPTION OF THE DRAWINGS

FIG. 1 is a plan view showing an electronic paper display device according to an exemplary embodiment of the present invention;

FIG. 2 is a cross-sectional view taken along line I-I′ shown in FIG. 1;

FIG. 3 is a flowchart showing a method for manufacturing an electronic paper display device according to an exemplary embodiment of the present invention; and

FIGS. 4 to 8 are drawings for explaining a process of manufacturing an electronic paper display device according to an exemplary embodiment of the present invention.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. Rather, these embodiments may be provided so that this disclosure will be thorough and complete, and will fully convey the scope of the invention to those skilled in the art. Like reference numerals in the drawings denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

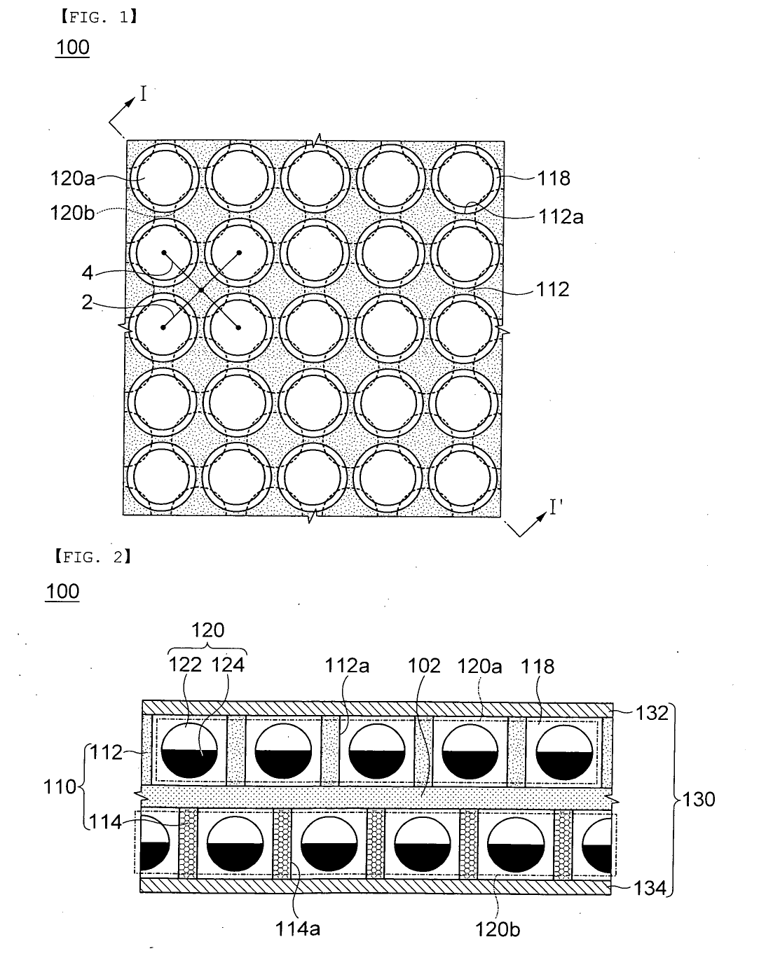

Hereinafter, an electronic paper display device and a method for manufacturing the same will be described in detail with reference to FIGS. 1 to 8.

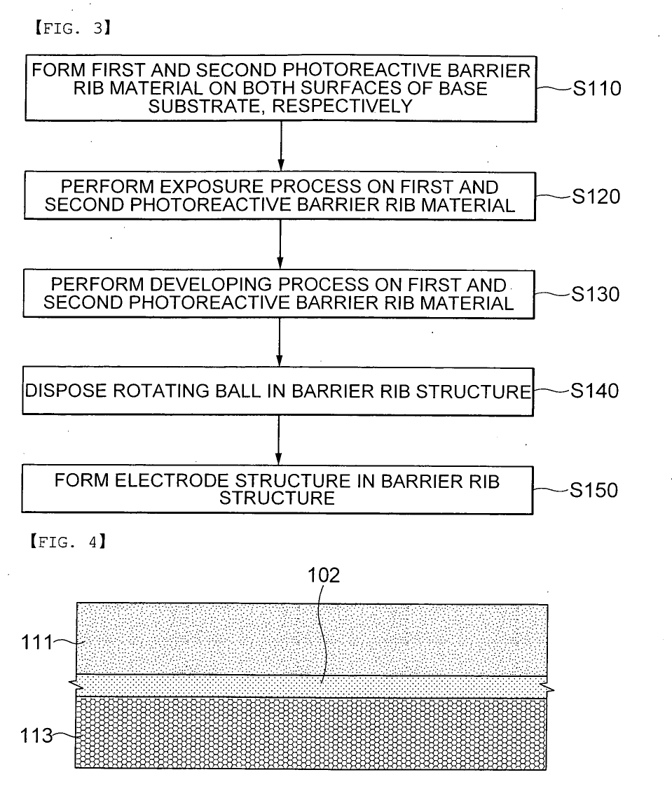

FIG. 1 is a plan view showing an electronic paper display device according to an exemplary embodiment of the present invention and FIG. 2 is a cross-sectional view taken along line I-I′ shown in FIG. 1.

Referring to FIGS. 1 and 2, an electronic paper display device 100 according to an embodiment of the present invention may include a base substrate 102, a barrier rib structure 110, rotating balls 120, and an electrode structure 130.

The base substrate 102 may be a plate to support components of the electronic paper display device 100. The base substrate 102 may include a light transmitting transparent substrate. As one example, the base substrate 102 may be a glass plate. As another example, the base substrate 102 may be a plate made of at least any one of polyethylene terephthalate (PET), polycarbonate (PC), polyethersulphone (PES), and polyimide (PI). As another example, the base substrate 102 may be a metal plate made of a metal material. When the base substrate 102 is a metal plate, the base substrate 102 may be used as an electrode to drive the rotating balls 120.

The barrier rib structure 110 can support and partition the rotating balls 120 on the base substrate 102. As one example, the barrier rib structure 110 may include a first barrier rib 112 disposed on the front surface of the base substrate 102 and a second barrier rib 114 disposed on the rear surface of the base substrate 102. The first barrier rib 112 may include first cavities 112a in which the rotating balls 120 are disposed and the second barrier rib 114 may include second cavities 114a in which the rotating balls 120 are disposed. The first cavities 112a and the second cavities 114a may be filled with a transparent insulating oil 118 to easily rotate the rotating balls 120 and provide lubrication to the rotating balls 120.

The rotating balls 120 may substantially have a spherical shape. The rotating balls 122 each may be formed of first and second hemispheres 122 and 124 that are electrified with different charges. Alternatively, the rotating balls 120 each may be formed of the first and second hemispheres 122 and 124 that are optionally electrified to only any one thereof. In addition, the first and second hemispheres 122 and 124 may have different colors. For example, when the color electronic paper display device 100 is a white/black display device, the first hemisphere 122 may be a white hemisphere and the second hemisphere 124 may be a black hemisphere. As another example, when the color electronic paper display device is a color display device, the first hemisphere 122 may be any one of a blue hemisphere, a yellow hemisphere, a red hemisphere and a green hemisphere, and the second hemisphere 124 may be a black hemisphere or a white hemisphere. The colors of the first and second hemispheres 122 and 124 of each of the rotating balls 120 may be changed and combined in various manners.

Meanwhile, as shown in FIG. 2, the rotating balls 120 may have a multi-layer structure by being disposed on different planes of the base substrate 102. In addition, the rotating balls may be disposed to have a zigzag structure to each other based on the base substrate 110. For example, the rotating balls 120 may be divided into first rotating balls 120a disposed on the front surface of the base substrate 110 and second rotating balls 120b disposed on the rear surface of the base substrate 110. In this configuration, the first rotating balls 120a are disposed to be spaced apart from each other by a predetermined interval and the second rotating balls 120b may be disposed in a region corresponding to a gap between the first rotating balls 120a. In other words, the second rotating balls 120b may be disposed to be opposite to a space between the first rotating balls 120a. Therefore, the second rotating balls 120b may represent color to the outside through the gap between the first rotating balls 120a. In order to implement the zigzag structure of the above-mentioned rotating balls 120, the first cavities 112a and the second cavities 114a of the barrier rib structure 110 may be disposed to have the zigzag structure to each other based on the base substrate 102.

In addition, as shown in FIG. 1, the rotating balls 120 may be disposed in a structure that minimizes the space between the rotating balls 120 when being viewed from a plane. For example, four first rotating balls 120a and one second rotating ball 120b may be formed in one group. It may be preferable that the first rotating balls 120a are disposed at a minimum interval. The rotating balls 120 may be disposed so that the centers of the second rotating balls 120b are disposed at a point where diagonal lines 2 and 4 connecting the centers of the first rotating balls 120a facing each other in a diagonal direction meet each other. In this case, edges of the first rotating balls 120a and edges of the second rotating balls 120b may overlap each other or may be adjacent to each other, when being viewed from a plane. The above-mentioned disposition minimizes the interval between the rotating balls 120 and minimizes a color representation dead zone of the gap between the rotating balls 120, thereby making it possible to improve the color representation and contrast ratio of the electronic paper display device 100.

The electrode structure 130 can rotate the rotating balls 120. For example, the electrode structure 130 may include a lower electrode 132 that is disposed under the barrier rib structure 110 and an upper electrode 134 that is disposed over the barrier rib structure 110. The lower and upper electrodes 132 and 134 selectively apply voltage to the rotating balls 120, thereby making it possible to rotate the rotating balls 120 in order that the hemisphere of the first and second hemispheres 122 and 124, having the color to be represented, faces the outside (the upper portion in FIG. 1).

Meanwhile, the barrier rib structure 110 may be formed by performing a photolithography process. To this end, the barrier rib structure 110 may be made of a photoreactive barrier rib material. For example, the barrier rib structure 110 may include an insulating resin, a hardener, and a photosensitive material. The insulating resin may include an epoxy resin-based material. The hardener may include at least one of phenol novolac and bisphenol novolac. The photosensitive material may include a photosensitive monomer and a photoinitiator. In addition, the photoreactive barrier rib material may further include a hardening accelerator and an inorganic filler.

In addition, the first barrier rib 112 and the second barrier rib 114 may be made of different materials. In more detail, the first barrier rib 112 and the second barrier rib 114 may be made of a material reacting to light having different wavelengths. As one example, the first barrier rib 112 may include a photoreactive material reacting to any one light of g-line, i-line, KrF excimer laser, ArF excimer laser, F2 laser, and extreme ultraviolet (EUV) and the second barrier rib 114 may include a photoreactive material reacting to the other light among the above-mentioned lights. Therefore, the first barrier rib 112 and the second barrier rib 114 may be made of different kinds of photosensitive barrier rib materials.

In this configuration, it may be preferable that at least first barrier rib 112 of the first barrier rib 112 and the second barrier rib 114 is made of a light transmitting material. That is, since the second rotating balls 120b represent colors to the outside through the gap between the first rotating balls 120a, it is preferable that the first barrier rib 112 partitioning the first rotating balls 120a is configured not to degrade the color representation of the second rotating balls 120b. Therefore, if at least first barrier rib 112 of the first barrier rib 112 and the second barrier rib 114 is made of the light transmitting material, the electronic paper display device 110 can advantageously represent color. To this end, the first barrier rib 112 may be made of a transparent material.

As described above, the electronic paper display device 110 according to the present invention may include the base substrate 102, the rotating balls 120 disposed on both surfaces of the base substrate 102 in the zigzag to each other based on the base substrate 102, and the barrier rib structure 110 partitioning the rotating balls 120 on the base substrate 102. Therefore, the electronic paper display device 100 according to the present invention is configured to allow the rotating balls 120b disposed on one plane to represent the color representation dead zone generated between the rotating balls 120a disposed on the other plane to minimize the color representation dead zone, thereby making it possible to improve the color sharpness and contrast ratio.

In addition, the electronic paper display device 100 according to the present invention includes the base substrate 102, the rotating balls 120 disposed on both surfaces of the base substrate 102 and the barrier rib structure 130 having the first and second cavities 120a and 120b partitioning the rotating balls 120, wherein the barrier rib structure 130 may be made of the photoreactive barrier rib material and may be foamed through the photolithography process. Therefore, the electronic paper display device 100 according to the present invention has a large aspect ratio of the first and second cavities 120a and 120b in which the rotating balls 120 are disposed, minimizes the thickness of the barrier rib of the barrier rib structure 110, and increases the number of rotating balls 120 per a unit area, thereby making it possible to improve the color sharpness and the contrast ratio.

Continuously, a method for manufacturing an electronic paper display device according to the present invention described above will be described in detail. Herein, the repeated description of the color electronic paper display device 100 will be omitted or simplified.

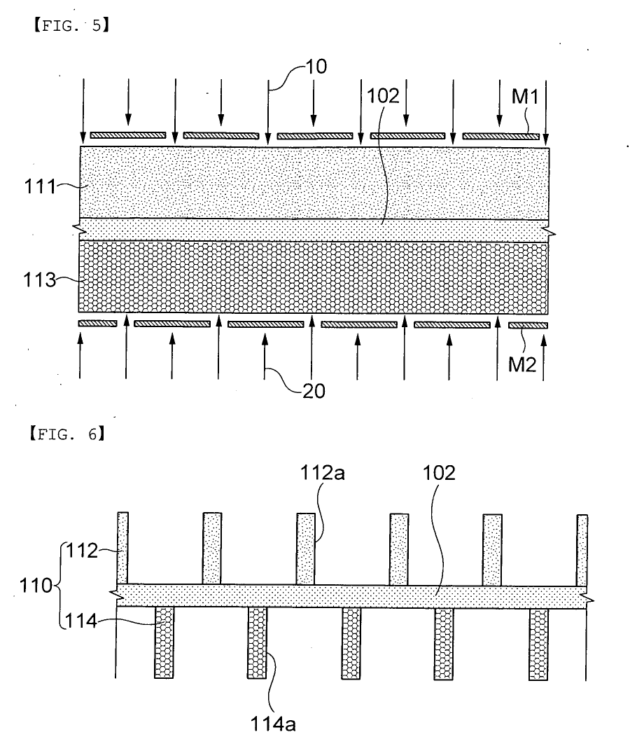

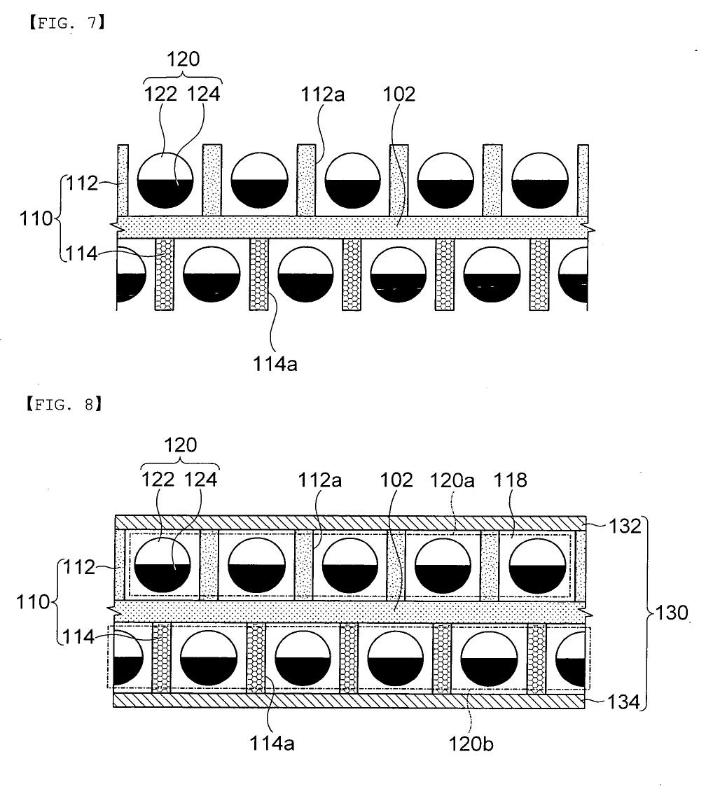

FIG. 3 is a flowchart showing a method for manufacturing an electronic paper display device according to an exemplary embodiment of the present invention and FIGS. 4 to 8 are drawings for explaining a process of manufacturing an electronic paper display device according to an exemplary embodiment of the present invention.

Referring to FIGS. 3 and 4, the first and second photoreactive barrier rib materials 111 and 133 may be formed on both surfaces of the base substrate 102 (S110). For example, the base substrate 100 may be prepared. As the base substrate 102, the light transmitting transparent plate may be used.

The first photoreactive barrier rib material 111 may be formed on the front surface of the base substrate 102 and the second photoreactive barrier rib material 113 may be formed on the rear surface of the base substrate 102. The forming the first and second photoreactive barrier rib materials 111 and 113 may include preparing a mixture by mixing an insulating resin, hardener, a hardening accelerator, an inorganic filler, and a photosensitive material, forming the first and second photoreactive barrier rib materials 111 and 113 with the mixture, and forming the photoreactive barrier rib materials 111 and 113 on the front and rear surfaces of the base substrate 102 at a uniform thickness. As the insulating resin, the epoxy resin may be used. As the photosensitive material, various kinds of polymer materials may be used.

The first and second photoreactive barrier rib materials 111 and 113 may be formed on the base substrate 102 in a film type through a film casting process. The thickness of each of the first and second photoreactive barrier rib materials 111 and 113 formed on the base substrate 102 may be controlled to be approximately 40 μm to 120 μm. After the first and second photoreactive barrier rib materials 111 and 113 formed in the film type are laminated under the predetermined temperature and pressure conditions, they can be dried. The pressure applied to the first and second photoreactive barrier rib materials 111 and 113 may be approximately 0.7 Kgf to 7.5 Kgf and the temperature may be controlled to be approximately 60° C. to 100° C.

The technology of forming the first and second photoreactive barrier rib materials 111 and 113 on the base substrate 102 can be diversified, but may not be limited to the above-mentioned examples. For example, the technology forming the first and second photoreactive barrier rib materials 111 and 113 may be performed using at least any one of a screen printing method, a curtain coating method, a roll coating method, an electrophoresis deposition method, and a spray coating method.

Meanwhile, the first photoreactive barrier rib material 111 and the second photoreactive barrier rib material 113 may be a material reacting to light having different wavelengths. For example, the first photoreactive barrier rib material 111 is a material reacting to any one light of g-line, i-line, KrF excimer laser, ArF excimer laser, F2 laser, and extreme ultraviolet (EUV) and the second photoreactive barrier rib material 113 may be a material reacting to the other light of g-line, i-line, KrF excimer laser, ArF excimer laser, F2 laser, and extreme ultraviolet (EUV).

Referring to FIGS. 3 to 5, the exposure process may be performed on the first and second photoreactive barrier rib materials 111 and 113 (S120). The performing the exposure process may include positioning a first mask Ml selectively light-shielding a region in which the first cavities (112a of FIG. 6) are formed on the first photoreactive barrier rib material 111, positioning a second mask M2 selectively light-shielding a region in which the second cavities (114a of FIG. 6) are formed on the second photoreactive barrier rib material 113, irradiating a first light 10 to the first photoreactive barrier rib material 111 through the first mask Ml, and irradiating a second light 20 having a wavelength different from that of the first light 10 to the second photoreactive barrier rib material 113 through the second mask M2. The irradiating the first light 10 and the irradiating the second light 20 may be performed in-situ. For example, the first and second lights 10 and 20 may be simultaneously irradiated to the base substrate 102.

In this configuration, the first light 10 may have a wavelength selectively reacting to the first photoreactive barrier rib material 111 and the second light 20 may have a wavelength selectively reacting to the second photoreactive barrier rib material 113. For example, the first light 10 may be any one light of g-line, i-line, KrF excimer laser, ArF excimer laser, F2 laser, and extreme ultraviolet (EUV) and the second light 20 may be the other light of g-line, i-line, KrF excimer laser, ArF excimer laser, F2 laser, and extreme ultraviolet (EUV). Therefore, even when the first light 10 irradiated to the front surface of the base substrate 102 transmits the base substrate 102 and is then irradiated to the second photoreactive barrier rib material 113, the cavities may not be formed in the second photoreactive barrier rib material 113. According to the same principle, even when the second light 20 irradiated to the rear surface of the base substrate 102 transmits the base substrate 102 and is then irradiated to the first photoreactive barrier rib material 111, the cavities may not be formed in the first photoreactive barrier rib material 111.

Meanwhile, after the exposure process, a first heat-treatment process to harden the first and second photoreactive barrier rib materials 111 and 113 may be further performed. The first heat-treatment process may a process of thermally hardening a part of the first and second photoreactive barrier rib materials 111 and 113 by performing a pre-cure process on the first and second photoreactive barrier rib materials 111 and 113.

Referring to FIGS. 3 to 6, the developing process may be performed on the first and second photoreactive barrier rib materials 111 and 113 (S130). For example, the performing the developing process may include supplying a developer to the first and second photoreactive barrier rib materials 111 and 113 subjected to the exposure process that is already described with reference to FIG. 5. Therefore, a non-light receiving region of the first and second photoreactive barrier rib materials 111 and 113 may be removed. Therefore, the front surface of the base substrate 102 may be formed with the first barrier rib 112 having the first cavities 112a and the rear surface of the base substrate 102 may be formed with the second barrier rib 114 having the second cavities 114a. The first barrier rib 112 and the second barrier rib 114 forms the barrier rib structure 110. In this case, the first cavities 112a and the second cavities 114a may be disposed in zigzag to each other based on the base substrate 102.

In this configuration, the first barrier rib 112 and the second barrier rib 114 are formed by the photolithography process, such that they may formed in a structure having the high aspect ratio. Therefore, the sides of the first and second barrier ribs 112 and 114 defining the first and second cavities 112a and 114a may be vertical and the transverse section thereof may have a circular shape. In this case, the first and second cavities 112a and 114a each may substantially have a cylindrical shape and thus, the upper opening diameter and the lower opening diameter of each of the cavities 112a and 114a may be the same as each other. In addition, the thickness of the first and second barrier ribs 112 and 114 at a portion adjacent to each other may be controlled within approximately 30 μm.

Meanwhile, after the developing process, a second heat-treatment process to harden the first and second photoreactive barrier rib materials 111 and 113 may be further performed. The second heat-treatment process hardens the first and second photoreactive barrier rib materials 11 and 113 at a temperature condition of approximately 150° C. or more.

Referring to FIGS. 3 and 7, the rotating balls 120 can be disposed in the barrier rib structure 110 (S140). For example, the first rotating balls 120a may be disposed on the front surface of the base substrate 102 while being self-aligned in the first cavities 112a of the first barrier rib 112. As a similar manner, the second rotating balls 120b may be disposed on the rear surface of the base substrate 102 while being self-aligned in the second cavities 114a of the second barrier rib 114 In this configuration, the first cavities 112a and the second cavities 114a are disposed in zigzag based on the base substrate 102 and thus, the first rotating balls 120a and the second rotating balls 120b may also be disposed in zigzag based on the base substrate 102.

In this case, the first barrier rib 112 and the second barrier rib 114 may be provided at a relatively thin thickness and the number of each of the first and second rotating balls 120a and 120b disposed per a unit area of the base substrate 102 can be increased. In addition, since the second rotating balls 120b have the plane arrangement disposed in a region corresponding to the gap between the first rotating balls 120a, the first rotating balls 120a and the second rotating balls 120b can increase the color representing region as compared to when only any one of the first rotating balls 120a and the second rotating balls 120b are disposed on the base substrate 102.

Referring to FIGS. 3 and 8, the electrode structure 130 can be formed on the barrier rib structure 110 (S150). The forming the electrode structure 130 may include disposing the lower electrode 132 under the barrier rib structure 110, and disposing the upper electrode 134 over the barrier rib structure 110. In addition, the forming the electrode structure 103 may further include introducing the transparent oil 118 into the first and second cavities 112a and 114a. The transparent oil 118 may be introduced into the first and second cavities 112a and 114a through the introducing hole (not shown) provided between the barrier rib structure 110 and the upper electrode 134.

As described above, the method for manufacturing the electronic paper display device according to the present invention can manufacture the electronic paper display device 100 including the first and second rotating balls 120a and 120b disposed in zigzag to each other on the front and rear surfaces of the base substrate 102 based on the base substrate 102. Therefore, the method for manufacturing the electronic paper display device according to the present invention allows the rotating balls disposed on any one plane to represent the color representation dead zone generated between the rotating balls 120a disposed on the other plane, thereby making it possible to manufacture the electronic paper display device with the improved color sharpness and contrast ratio.

In addition, the method for manufacturing the electronic paper display device according to the present invention prepares the first and second photoreactive barrier rib materials 111 and 113 reacting to light having different wavelengths and performs the photolithography process on the first and second photoreactive barrier rib materials 111 and 113, thereby making it possible to form the barrier rib structure 110 partitioning the first and second rotating balls 120a and 120b disposed in zigzag to each other based on the base substrate 102. In this case, the first and second barrier ribs 112 and 114 of the barrier rib structure 110 partitioning the first and second rotating balls 120a and 120b can be formed at the thin thickness while having the high aspect ration. As a result, the method for manufacturing the electronic paper display device according to the present invention increases the number of rotating balls 120 per a unit area, thereby making it possible to the electronic paper display device 100 with the improved color sharpness and contrast ratio.

The electronic paper display device according to the present invention includes the base substrate, the first rotating balls disposed on the front surface of the base substrate, the second rotating balls disposed on the rear surface of the base substrate, wherein the first and second rotating balls may be disposed in zigzag based on the base substrate. Therefore, the electronic paper display device according to the present invention is configured to allow the rotating balls disposed on any one plane to represent the color representation dead zone of the gap between the rotating balls disposed on the other plane, thereby making it possible to improve the color sharpness and contrast ratio.

The electronic paper display device according to the present invention includes the first rotating balls disposed on the front surface of the base substrate, the second rotating balls disposed on the rear surface of the base substrate, and the barrier rib structure partitioning the first rotating balls and the second rotating balls, wherein the barrier rib structure may be formed in the photo resist process. As a result, the electronic paper display device according to the present invention can minimize the thickness of the barrier rib of the barrier rib structure to increase the number of rotating balls per a unit area, thereby making it possible to improve the color sharpness and the contrast ratio.

The method for manufacturing the electronic paper display device according to the present invention can manufacture the electronic paper display device that includes the base substrate, the first rotating balls disposed on the front surface of the base substrate, the second rotating balls disposed on the rear surface of the base substrate, wherein the first and second rotating balls may be disposed in zigzag based on the base substrate. Therefore, the method for manufacturing the electronic paper display device according to the present invention allows the rotating balls disposed on any one plane to represent the color representation dead zone of the gap between the rotating balls disposed on the other plane, thereby making it possible to manufacture the electronic paper display device with the improved color sharpness and contrast ratio.

The method for manufacturing the electronic paper display device according to the present invention prepares the first and second photoreactive barrier rib material reacting to light having different wavelengths to form the barrier rib structure partitioning the first and second rotating balls disposed at both surfaces, respectively, based on the base substrate, wherein the barrier rib structure may be formed in the photoresist process. As a result, the method for manufacturing the electronic paper display device according to the present invention minimizes the thickness of the barrier rib of the barrier rib structure to increase the number of rotating balls per a unit area, thereby making it possible to manufacture the electronic paper display device with the improved color sharpness and contrast ratio.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. An electronic paper display device, comprising:
a base substrate;
first rotating balls that are disposed on the front surface of the base substrate;
second rotating balls that are disposed on the rear surface of the base substrate; and
a barrier rib structure that partitions the first rotating balls and the second rotating balls on the base substrate and is made of a photoreactive barrier rib material.

2. The electronic paper display device according to claim 1, wherein the first rotating balls and the second rotating balls are disposed to have a zigzag structure to each other based on the base substrate.

3. The electronic paper display device according to claim 1, wherein the plane arrangement of the first rotating balls and the second rotating balls has a structure where one center of the second rotating ball is positioned at a connection point of lines connecting the centers of the first rotating balls facing each other in a diagonal direction among four first rotating balls.

4. The electronic paper display device according to claim 1, wherein the barrier rib structure includes:
a first barrier rib that is disposed on the front surface of the base substrate to partition the first rotating balls; and
a second barrier rib that is disposed on the rear surface of the base substrate to partition the second rotating balls,
the first barrier rib and the second barrier rib including different kinds of photoreactive barrier rib materials.

5. The electronic paper display device according to claim 1, wherein the barrier rib structure includes:
a first barrier rib that is disposed on the front surface of the base substrate to partition the first rotating balls; and
a second barrier rib that is disposed on the rear surface of the base substrate to partition the second rotating balls,
the first barrier rib including a photoreactive barrier rib material reacting to light having different wavelengths as compared to the second barrier rib.

6. The electronic paper display device according to claim 1, wherein the barrier rib structure includes:
a first barrier rib that is disposed on the front surface of the base substrate to partition the first rotating balls; and
a second barrier rib that is disposed on the rear surface of the base substrate to partition the second rotating balls,
at least first barrier rib of the first barrier rib and the second barrier rib being made of a light transmitting material.

7. The electronic paper display device according to claim 1, wherein the barrier rib structure includes cavities in which the first rotating balls and the second rotating balls are disposed, the cavities having a cylindrical shape.

8. The electronic paper display device according to claim 1, wherein the barrier rib structure includes cavities in which the first rotating balls and the second rotating balls are disposed, and
the upper diameter and the lower diameter of the cavities being the same as each other.

9. The electronic paper display device according to claim 1, wherein the barrier rib structure includes:
first cavities in which the first rotating balls are disposed; and
second cavities in which the second rotating balls are disposed,
the first cavities and the second cavities being disposed in zigzag to each other based on the base substrate.

10. The electronic paper display device according to claim 1, wherein the barrier rib structure includes a barrier rib defining the cavities in which the first rotating balls and the second rotating balls are disposed, and
the barrier rib being vertical and having a side surface surrounding the cavities.

11. The electronic paper display device according to claim 1, wherein the barrier rib structure includes a barrier rib defining the cavities in which the first rotating balls and the second rotating balls are disposed,
the thickness of the barrier rib of a portion that partitions the rotating balls adjacent to each other among the first rotating balls being 30 μm or less.

12. The electronic paper display device according to claim 1, wherein the first barrier rib includes a photoreactive material reacting to any one of g-line, i-line, KrF excimer laser, ArF excimer laser, F2 laser, and extreme ultraviolet (EUV), and
the second barrier rib includes a photoreactive material reacting to the other light of g-line, i-line, KrF excimer laser, ArF excimer laser, F2 laser, and extreme ultraviolet (EUV).

13. The electronic paper display device according to claim 1, wherein the base substrate includes a light transmitting transparent substrate.

14. The electronic paper display device according to claim 1, further comprising an electrode structure applying voltage to the rotating balls,
wherein the electrode structure includes:
an upper electrode that is disposed on the first rotating balls; and
a lower electrode that is disposed on the second rotating balls.

15. An electronic paper display device, comprising:
a base substrate;
rotating balls that are disposed on the base substrate by being divided on two or more different planes; and
a barrier rib structure that partitions the rotating balls,
the barrier rib structure being formed by performing a photolithography process.

16. The electronic paper display device according to claim 15, wherein the rotating balls disposed on different planes among the rotating balls are disposed in zigzag to each other based on the base substrate.

17. The electronic paper display device according to claim 15, wherein the rotating balls disposed on any one plane among the rotating balls are disposed to be opposite to a region between the rotating balls disposed on the other plane.

18. The electronic paper display device according to claim 15, wherein the rotating balls include:
first rotating balls that are disposed on any one plane on the base substrate;
second rotating balls that are disposed on the other plane on the base substrate; and
wherein the barrier rib structure includes:
a first barrier rib that partitions the first rotating balls; and
a second barrier rib that partitions the second rotating balls.

19. The electronic paper display device according to claim 15, wherein the rotating balls include:
a first rotating balls that are disposed on any one plane on the base substrate; and
a second rotating balls that are disposed on the other plane on the base substrate,
the plane arrangement of the first rotating balls and the rotating balls having a structure where one center of the second rotating ball is positioned at a connection point of lines connecting the centers of the first rotating balls facing each other in a diagonal direction among four first rotating balls.

20. The electronic paper display device according to claim 15, wherein the barrier rib structure includes:
a first barrier rib that partitions the rotating balls disposed on any one plane of the base substrate; and
a second barrier rib that partitions the rotating balls disposed on the other plane of the base substrate,
the first barrier rib including a photoreactive barrier rib material reacting to light having different wavelengths as compared to that of the second barrier rib.

21. The electronic paper display device according to claim 15, wherein the rotating balls include:
first rotating balls that are disposed on any one plane on the base substrate; and
second rotating balls that are disposed on the other plane on the base substrate, and
wherein the electrode structure includes:
an upper electrode that covers the first rotating balls on the front surface of the base substrate; and
a lower electrode that covers the second rotating balls on the rear surface of the base substrate.

22. A method for manufacturing an electronic paper display device, comprising:
preparing a base substrate;
forming a photoreactive barrier rib material on both surfaces of the base substrate;
forming cavities in the photoreactive barrier rib material;
positioning rotating balls in the cavities; and
forming an electrode structure applying voltage to the rotating balls in the barrier rib structure.

23. The method for manufacturing an electronic paper display device according to claim 22, wherein the forming the photoreactive barrier rib material includes:
forming a first photoreactive barrier rib material on the front surface of the base substrate; and
forming a second photoreactive barrier rib material of a type different from the first photoreactive barrier rib materialial on the rear surface of the base substrate.

24. The method for manufacturing an electronic paper display device according to claim 22, wherein the forming the photoreactive barrier rib material includes:
forming a first photoreactive barrier rib material on the front surface of the base substrate; and
forming a second photoreactive barrier rib material reacting to light having a wavelength different from that of the first photoreactive barrier rib material on the rear surface of the base substrate.

25. The method for manufacturing an electronic paper display device according to claim 22, wherein the forming the photoreactive barrier rib material includes:
forming a first photoreactive material reacting to any one of g-line, i-line, KrF excimer laser, ArF excimer laser, F2 laser, and extreme ultraviolet (EUV) on the front surface of the base substrate; and
foaming a second photoreactive material reacting to the other light of g-line, i-line, KrF excimer laser, ArF excimer laser, F2 laser, and extreme ultraviolet (EUV) on the rear surface of the base substrate.

26. The method for manufacturing an electronic paper display device according to claim 22, wherein the forming the cavities includes:
forming first cavities in the photoreactive barrier rib materialial formed on the front surface of the base substrate; and
forming second cavities opposite to a region between the first cavities in the photoreactive barrier rib material formed on the rear surface of the base substrate.

27. The method for manufacturing an electronic paper display device according to claim 22, wherein the forming the cavities includes:
forming first cavities in the photoreactive barrier rib material formed on the front surface of the base substrate; and
forming second cavities having a zigzag structure to the first cavities based on the base substrate in the photoreactive barrier rib material formed on the rear surface of the base substrate.

28. The method for manufacturing an electronic paper display device according to claim 22, wherein the forming the cavities includes:
forming first cavities in the photoreactive barrier rib material formed on the front surface of the base substrate; and
forming second cavities in the photoreactive barrier rib material formed on the rear surface of the base substrate, and
the forming the cavities and the forming the second cavities being performed in-situ.

29. The method for manufacturing an electronic paper display device according to claim 22, wherein the forming the cavities includes:
forming first cavities in the photoreactive barrier rib material formed on the front surface of the base substrate; and
forming second cavities in the photoreactive barrier rib material formed on the rear surface of the base substrate,
the forming the first cavities being made by performing a photolithography process using light having a different wavelength as compared to the forming the second cavities.

30. The method for manufacturing an electronic paper display device according to claim 22, wherein the positioning the rotating balls in the cavities includes:
positioning first rotating balls disposed on the front surface of the base substrate; and
positioning second rotating balls to have a zigzag arrangement to the first rotating balls on the rear surface of the base substrate based on the base substrate.

31. The method for manufacturing an electronic paper display device according to claim 22, further comprising hardening the photoreactive barrier rib material.

32. The method for manufacturing an electronic paper display device according to claim 22, wherein the forming the cavities includes:
positioning a first mask on a photoreactive barrier rib material formed on the front surface of the base substrate;
positioning a second mask on a photoreactive barrier rib material formed on the rear surface of the base substrate;
performing a second exposure process irradiating light having a first wavelength to the photoreactive barrier rib material through the first mask;
performing a first exposure process irradiating light having a wavelength different from the first wavelength to the photoreactive barrier rib material through the second mask; and
performing a developing process removing a non-light receiving region of the light of the photoreactive barrier rib material.

33. The method for manufacturing an electronic paper display device according to claim 22, wherein the first exposure process and the second exposure process are performed in-situ.

34. The method for manufacturing an electronic paper display device according to claim 22, wherein the forming the electrode structure further includes:
forming an upper electrode on the front surface of the base substrate; and
forming a lower electrode on the rear surface of the base substrate.
